(19) United States
(12) Patent Application Publication
(10) Pub. No.: US 2008/0053375 A1
(43) Pub. Date: Mar. 6, 2008

(54) Hummingbird feeder

(75) Inventors: Richard K. Jung, Laguna Niguel, CA (US); Joie L. Puckett, Long Beach, CA (US)

Correspondence Address: JACOBSON HOLMAN PLLC, 400 SEVENTH STREET N.W., SUITE 600, WASHINGTON, DC, 20004, US

(73) Assignee: PERKY-PET PRODUCTS COMPANY, INC., Denver, CO (US)

(21) Appl. No.: 11/892,164

(22) Filed: Aug. 20, 2007

Related U.S. Application Data
(63) Continuation of application No. 11/162,319, filed on Sep. 6, 2005, now abandoned.
Application No. 11/162,319 is a continuation of application No. 29/210,625, filed on Aug. 2, 2004, now Pat. No. D509325.

(51) Int. Cl. A01K 7/00

(52) U.S. Cl. 119/72

(57) ABSTRACT

A bird feeder that is to be suspended from a support includes a container disposed on a base that has at least one outer opening operative to dispense foodstuff from the container. A hanger member is centrally located on a top portion of the container. An upstanding barrier wall extends around the hanger in spaced relation so as to form a channel surrounding the hanger. This channel may be filled with a liquid to serve as an ant moat. The top portion may be circular and have a post projecting upwardly with the hanger member supported on the post. The barrier wall is then circumjacent this post to form an annular channel. The barrier wall may be located on the periphery of the top portion and also may be coextensive with the side wall of the container. The base may be provided with a perch for a bird.

This is a continuation of application Ser. No. 11/162,319 filed Sep. 6, 2005, which in turn is a continuation of Ser. No. 29/210,625 filed Feb. 8, 2004 now Patent No. D509325.

### FIELD OF THE INVENTION

The present invention generally relates to feeders for storing and dispensing foodstuff to living things, such as birds, butterflies, and the like. The present invention more particularly relates to bird feeders that are useful for dispensing nectar solutions for consumption by hummingbirds.

### BACKGROUND OF THE INVENTION

Bird-watching is a highly prevalent past-time in both urban and rural areas. The world is full of birds of numerous varieties in an astounding array of colors and designs. Many people enjoy viewing birds of various types, and an industry has grown up around products directed to improving the ability of persons to get close to birds. On one hand, many people venture into the outdoors, where binoculars and spotting scopes may be utilized to better view various birds in their natural habitats. Such an approach requires a certain degree of skill, however, in finding and spotting various species of birds. Another approach utilizes various means of attracting birds to one's residence or a desired viewing location, such as adjacent a home porch or window, where birds may be viewed at one's leisure.

In particular, the art of using bird feeders, bird baths, and the like has arisen to attract birds of various types to one's home. Different types of feeders have been developed, which each dispense foodstuffs that are preferred by a selected variety of bird which a person might desire to view. For example, seeds, grains, suets, and nectars are common foodstuffs that can be dispensed by a selected type of feeder.

Hummingbirds are one particularly interesting type of bird that persons commonly desire to view. The hummingbird family is found only in the Americas, and includes more than 300 species of birds. Hummingbirds are known for their rapid flight and their ability to hover in the air, such as at a food source, and fly backwards (the only birds capable of doing so). In particular, they feed on nectar and tiny insects found within flowers, generally hovering in front of a flower as they reach for food with long, extensible tongues. Their rapid wing beat produces a hum, and they are generally brightly colored and iridescent, thus particularly enjoyable to view. Many male hummingbirds have metallic green coloring with brightly colored throats, which are often a glittering red, blue, or emerald. They are often seen hovering or darting, and have been known to reach speeds up to 60 miles per hour in the air, beating their wings at 50 to 75 beats per second.

Various types of feeders have been developed to attract hummingbirds to a particular location for viewing. Many people hang such feeders from porches or backyard trees, so as to be able to watch various brightly colored birds arrive and depart, hovering or sometimes perching at the feeder in the interim to feed. Due to the enormous energy requirements of their particular flight patterns, hummingbirds require virtually constant feeding of high-sugar content foodstuffs.

Accordingly, it is generally common to provide a nectar-like solution for hummingbirds from a brightly colored feeder designed to simulate the colors of flowers to which hummingbirds are generally attracted, such as red in particular. Such feeders can additionally be utilized by orioles and butterflies, which one may also desire to attract and view by providing appropriate feeders and nectars therefor. It is also desirable that such feeders have an aesthetically appealing look, so as not to detract from the appearance of the structure or locale in which the feeder is placed.

Such feeders generally include a reservoir and one or more openings from which a hummingbird or other creature can access the nectar. Flower designs, such as petals and the like, are generally provided to simulate a more natural nectar source for the consuming creatures. Many designs for such feeders provide an inverted reservoir that has openings located below the level of the solution such that the solution is continually provided to the openings for access by the consuming creatures.

In addition to attracting hummingbirds, these bird feeders also attract pests, such as ants and other insects. Ants generally crawl down the suspension member, which suspends the feeder from a support, on to the reservoir, and then to the openings to access the nectar. Oftentimes, the ants will drown in the nectar, which is both unsightly and can contaminate the nectar. One way to keep ants from gaining access to the openings is to position a device that acts as a barrier in a place that prohibits the ants from reaching the openings. One such barrier is commonly referred to as an ant moat, which is generally a receptacle for receiving water. As the ants travel toward the openings in the bird feeder, they encounter the ant moat and, ideally are trapped in the water or other substance held thereby.

Ant moats are typically effective in serving as a barrier for ants that attempt to reach the openings in hummingbird feeders. Despite this effectiveness, there is still a need for an improved bird feeder having an ant moat associated therewith that accomplishes this barrier system. The present invention is directed to meeting this need.

### SUMMARY

According to the exemplary embodiment disclosed herein, a bird feeder is provided that is adapted to be suspended from a support and operative to store and dispense a foodstuff for a bird. The bird feeder generally includes a base and a container disposed thereon. The base has at least one outer opening that is operative to dispense foodstuff to a bird, but may include a plurality of such openings. The base may further be provided with a perch disposed thereon and proximately to the outer openings. The perch may be formed as a rim that surrounds the base.

The container is disposed on the base and is adapted to receive the foodstuff for the birds and may be generally cylindrical with a longitudinal central axis. The container includes a surrounding side wall having an outer side wall surface, a top portion, hanger member, and an upstanding barrier wall. The top portion of the container is generally circular in configuration and the hanger member is centrally located on the top portion and aligned with the central axis. The upstanding barrier wall extends around the hanger member in spaced relation thereto so as to form a channel surrounding the hanger member, which may be annular in configuration.

The top portion has a periphery and the upstanding barrier wall is located on the periphery thereof. The barrier wall has an outer barrier wall surface that is coextensive with the side wall surface of the container. The barrier wall extends circumjacent to and spaced from the hanger member such that the channel formed thereby is annular in configuration.

The top portion may also include a post projecting upwardly therefrom and supporting the hanger member. The hanger member may include an eyelet portion.

### BRIEF DESCRIPTION OF THE DRAWINGS

FIG. 1 is a perspective view of the feeder according to the exemplary embodiment of the present invention;

FIG. 2 is front view in elevation of the feeder shown in FIG. 1; and

FIG. 3 is a top plan view of the hummingbird feeder shown in FIG. 1.

### DETAILED DESCRIPTION OF THE EXEMPLARY EMBODIMENT

The disclosed embodiment generally relates to a feeder that is adapted to store and dispense foodstuff for the care and feeding of animals. More particularly, the disclosed embodiment concerns a bird feeder adapted to be suspended from a support member such as a tree limb, beam, or roof overhang and that is particularly useful for dispensing nectar to hummingbirds. One aspect of the hummingbird feeder disclosed herein is the top portion thereof, which has a barrier wall that extends around a hanger member. The channel is adapted to receive and hold liquid, such as water, thereby forming an ant moat to serve as a barrier to ants seeking the nectar. Although the exemplary embodiment shown herein

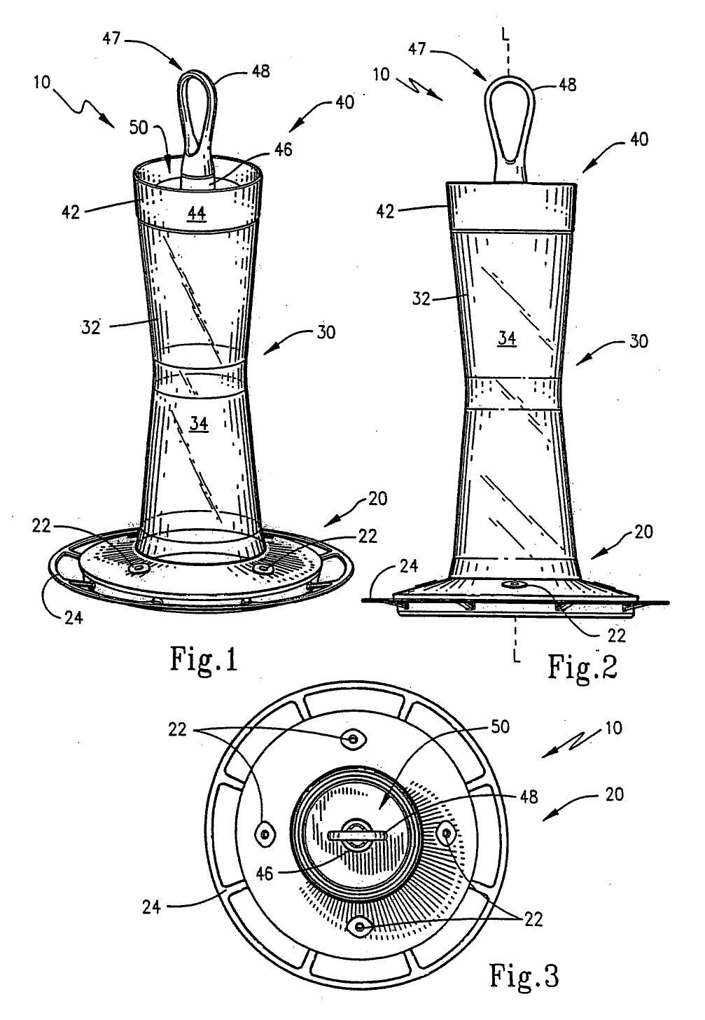

An exemplary embodiment of the feeder according to the present invention is shown in FIGS. 1 through 3, which show feeder 10 in the form of a hummingbird feeder. Feeder 10 is adapted to be suspended from a support and operative to store and dispense a foodstuff, such as nectar for a bird. Feeder 10 broadly includes base 20 and container 30. As shown here, base 20 is a circular structure that may be formed may be formed of metal, plastic, and the like. Base 20 has a plurality of outer openings 22 each of which are operative to dispense the foodstuff for the birds. Outer openings 22 may be bounded by flower structures to make base 20 more attractive to hummingbirds. Base 20 also includes perch 24 disposed on base 20 proximately to outer openings 22. As shown here, perch 22 may be formed as a rim that surrounds base 20, however, it is not limited to this structure.

Container 30 is disposed on base 20 and is adapted to receive the foodstuff for birds. Container 30 generally includes top portion 40, hanger member 48, and upstanding barrier wall 42, each of which will be explained in more detail below. Container 30 may be formed of glass, plastic or the like, and can be generally cylindrical in configuration as shown here, although other configurations, such as polygonal, circular, or oval, are also contemplated. Container 30 has a longitudinal central axis “L” and a surrounding side wall 32 with an outer wall surface 34.

Top portion 40 of container 30 is circular in configuration and has a periphery wherein upstanding barrier wall 42 thereof is located on the periphery. Barrier wall 42 has an outer barrier wall surface 44 that is coextensive with container sidewall surface 34. Top portion 40 also includes post 46 projecting upwardly therefrom and supporting hanger member 46. Hanger member 46 is centrally located and aligned with central axis “L” and includes an eyelet portion 47. Hanger member 46 is adapted to suspend feeder 10 from a suitable support, such as a tree limb, beam, or roof overhang. Barrier wall 42 extends circumjacent to hanger member 48 and in spaced relation thereto so as to form annular channel 50 thereabout. Channel 50 can, if desired, be filled with liquid, such as water, thereby to serve as an ant moat.

Accordingly, the embodiment of the present invention has been described with some degree of particularity. It should be appreciated, though, that the scope of the claimed invention is set forth in the following claims such that the exemplary embodiment should not limit the scope of the invention. That is, it should be clearly understood that modifications or changes may be made to the exemplary embodiment of the present invention without departing from the inventive concepts contained herein.

1. A hummingbird feeder adapted to be suspended from a support and operative to store and dispense a nectar for a hummingbird, comprising:
(A) a base having at least one outer opening operative to dispense said nectar to said hummingbird; and
(B) a container adapted to receive the nectar and disposed on said base, said container including a surrounding side wall with an outer side wall surface, a top portion having a generally flat upper surface defined by a periphery and supported by a hanger member extending from an upstanding post located on said top portion, and an upstanding barrier wall extending upwardly from said periphery and around said post in spaced relation thereto so as to form a channel surrounding said post, said barrier wall having an upper edge which defines a barrier wall top plane that is substantially parallel to said top portion flat upper surface and having an outer barrier wall surface coextensive with said side wall surface.

2. The hummingbird feeder according to claim 1 wherein said base has a plurality of outer openings, each operative to dispense said nectar to said hummingbird.

3. The hummingbird feeder according to claim 1 including a perch disposed on said base proximately to the outer opening.

4. The hummingbird feeder according to claim 3 wherein said perch extends as a rim from said base.

5-6. (canceled)

7. The hummingbird feeder according to claim 1 wherein said top portion and said post are circular in shape, and said barrier wall extends circumjacent to and spaced from said post such that the channel is annular in configuration.

8. (canceled)

9. The hummingbird feeder according to claim 1 wherein said hanger member includes an eyelet portion.

10-17. (canceled)

18. The hummingbird feeder according to claim 1, wherein a plane at which said hangar member is supported on said post is equal to or higher than said barrier wall top plane.
